(19) United States
(12) Patent Application Publication
(10) Pub. No.: US 2020/0215770 A1
(43) Pub. Date: Jul. 9, 2020

(54) PULTRUSION METHOD AND EQUIPMENT FOR PREPARING A FIBER-REINFORCED COMPOSITE

(71) Applicant: Covestro Deutschland AG, Leverkusen (DE)

(72) Inventors: Yongming Gu, Shanghai (CN); Zhijiang Li, Shanghai (CN); James Chen, Suzhou City (CN); Chenxi Zhang, Shanghai (CN); Guobin Sun, Shanghai (CN); Hui Zhang, Shanghai (CN)

(21) Appl. No.: 16/615,274

(22) PCT Filed: Jun. 11, 2018
(86) PCT No.: PCT/EP2018/065296

§ 371 Date: Nov. 20, 2019

(30) Foreign Application Priority Data
Jun. 12, 2017 (CN) 201710467995.6

(51) Int. Cl. B29C 70/52; C08J 5/04

(52) U.S. Cl. CPC B29C 70/523; B29K 2075/00; C08J 5/043; B29C 70/527

(57) ABSTRACT

A pultrusion method, equipment for preparing a fiber-reinforced composite, and a fiber-reinforcement composite are provided. The pultrusion method comprises the following steps: i) preforming inner layer fibers; ii) impregnating the preformed inner layer fibers with a first resin to obtain a first preform; iii) heating and curing the first preform to obtain an inner layer profile; iv) preforming outer layer fibers together with the inner layer profile; v) impregnating the outer layer fibers with a second resin to obtain a second preform; and vi) heating and curing the second preform to obtain the fiber-reinforced composite.

### FIELD OF THE INVENTION

The present invention belongs to the composite processing field, and specifically relates to a pultrusion method and equipment for preparing a fiber-reinforced composite.

### BACKGROUND

Pultrusion method is a widely used method for producing a fiber-reinforced composite. It continuously leads the fiber yarn or fiber fabric from the creel, and performs resin impregnation by an open dip bath or a sealed infusion box. After the fiber is impregnated with the resin, it enters into a mold with a certain cross-sectional shape and is heated and cured, then continuously pulled out of the mold by a traction device, and finally cut by an in-situ cutting device to the required length.

In view of its characteristics such as a high fiber content, simple and efficient technology, continuous production and uniform quality, the pultruded fiber-reinforced composite has become more and more widely used.

However, the equipment for use in the existing pultrusion technology usually comprises only one impregnating device and one curing mold, so that production efficiency tends to be relatively low when articles of thicker dimensions are manufactured, resulting in increased production costs. Meanwhile, as there is only one impregnating device, it means that only one resin can be used in production. If the resin material has undesirable weatherability, taking aromatic polyurethane resin as an example, a thin layer of resin covering the fiber on the surface of the composite may easily pulverize and discolor, resulting in color change, gloss loss and even fiber exposure on the surface of the pultruded composition material when subjected to long-term outdoor exposure and ultraviolet (UV) light, thereby affecting the appearance and properties of the pultruded composite.

At present, the common practice for treatment is to coat and protect the pultruded composite by offline spray coating technology after the profile is formed. Since the spray coating technology has a low lacquering rate and comprises many coating processes, it is both time-consuming and labor-intensive, leading to high cost in coating. Moreover, the currently applicable lacquers are mostly solvent-based products, thereby bringing new environmental problems.

Therefore, it is necessary to find a pultrusion method that is environmentally friendly and capable of producing articles of thicker dimensions.

Canadian patent CA2641050A1 and U.S. patent application US20090023870A1 disclose a two-step pultrusion production method. The method comprises passing the inner layer fibers through a yarn guiding means into a first infusion box and impregnating the fibers with a first resin, passing outer layer fibers and the inner layer fibers impregnated with the resin simultaneously into a second infusion box for impregnation again. The fibers or fabrics that have been impregnated twice simultaneously enter a curing mold to be cured at a certain temperature. It is mentioned in the patents that if the outer layer is cured after the curing of the inner layer, the inner and outer layers would have poor adhesive strength therebetween, and even peel off from each other. However, in the process of implementing the method, the inner and outer resins would easily mix up, which means that the inner layer resin would emerge to the surface. In other words, it cannot solve the problem of weatherability. Meanwhile, simultaneous curing of both the inner and outer layers means inability of producing thicker articles.

Therefore, it is desirable to develop a method that is environmentally friendly and capable of efficiently producing a thicker fiber-reinforced composite.

### SUMMARY OF THE INVENTION

The technical problem to be solved in the present invention is to provide a method that is environmentally friendly and capable of efficiently producing a thicker fiber-reinforced composite.

The following technical solution can be used to solve the technical problem of the invention:

According to a first aspect of the present invention, there is provided a pultrusion method for preparing a fiber-reinforced composite, comprising the following steps:
i) preforming inner layer fibers;
ii) impregnating the preformed inner layer fibers with a first resin to obtain a first preform;
iii) heating and curing the first preform to obtain an inner layer profile;
iv) preforming outer layer fibers together with the inner layer profile;
v) impregnating the outer layer fibers with a second resin to obtain a second preform; and
vi) heating and curing the second preform to obtain the fiber-reinforced composite.

According to a second aspect of the present invention, there is provided a fiber-reinforced composite prepared according to the method in the first aspect of the present invention.

According to a third aspect of the present invention, there is provided a pultrusion equipment for preparing a fiber-reinforced composite, comprising:
i) a first preforming device for receiving and preforming inner layer fibers;
ii) a first impregnating device for receiving the preformed inner layer fibers and impregnating the preformed inner layer fibers with a first resin to obtain a first preform;
iii) a first curing device for receiving the first preform and curing the first preform to obtain an inner layer profile;
iv) a second preforming device for receiving the outer layer fibers and the inner layer profile and preforming outer layer fibers with the inner layer profile;
v) a second impregnating device for receiving the preformed outer layer fibers and the inner layer profile and impregnating the outer layer fibers with a second resin to obtain a second preform;
vi) a second curing device for curing the second preform to obtain the fiber-reinforced composite; and
vii) a traction device for pulling the obtained fiber-reinforced composite.

By arranging a curing step between the two impregnating steps, the method of the present invention can realize stepwise curing of the fiber-reinforced composite. With this method, a thicker fiber-reinforced composite and a fiber-reinforced composite which requires impregnation with two resins can be efficiently obtained, thereby intermingling of inner and outer layer resins and infiltration of the inner layer resin into the outer layer can be avoided. Moreover, the method of the present invention can be effectively carried out by arranging a curing device between two impregnating devices in the equipment of the present invention.

### BRIEF DESCRIPTION OF THE FIGURES

The figures are for the purpose of illustration of the present invention, wherein:

FIG. 1 shows a flow chart of a pultrusion method for preparing a fiber-reinforced composite in accordance with an embodiment of the present invention, wherein:
1: Inner layer fibers; 2: First preforming device; 3: First impregnating device; 4. First curing device; 5: Inner layer profile; 6: Outer layer fibers; 7: Second preforming device; 8: Second impregnating device; 9: Second curing device; 10: Composite; 11: Traction device.

FIG. 2 is a flow chart of a pultrusion method for preparing a fiber-reinforced composite in accordance with the conventional one-step curing method, wherein:
12: Fibers; 13: Preforming device; 14: Impregnating device; 15: Curing device; 16: Profile; 17: Traction device.

FIG. 3 is a photograph of the destroyed glass fiber-reinforced composite prepared in Example 1.

### DETAILED DESCRIPTION OF THE INVENTION

The embodiments of the present invention are illustrated as follows:

According to a first aspect of the present invention, there is provided a pultrusion method for preparing a fiber-reinforced composite, comprising the steps of:
i) preforming inner layer fibers;
ii) impregnating the preformed inner layer fibers with a first resin to obtain a first preform;
iii) heating and curing the first preform to obtain an inner layer profile;
iv) preforming outer layer fibers together with the inner layer profile;
v) impregnating the outer layer fibers with a second resin to obtain a second preform; and
vi) heating and curing the second preform to obtain the fiber-reinforced composite.

The inner layer fibers may be any of the fibers used to reinforce the resin, for example, one or more selected from the group consisting of glass fibers, carbon fibers, polyester fibers, natural fibers, aromatic polyamide fibers, nylon fibers, basalt fibers, boron fibers, silicon carbide fibers, asbestos fibers, whiskers, and metal fibers.

The inner layer fibers may be in the form of yarns, unidirectional fabrics, biaxial fabrics, triaxial fabrics, continuous felts, knitted felts, chopped strand felts, knitted fabrics, woven fabrics, and the like.

The first resin may be any resin that needs to be reinforced, for example, one or more selected from the group consisting of aromatic polyurethane, epoxy resin, unsaturated resin, aliphatic polyurethane, and vinyl resin.

The content of the inner layer fiber generally ranges from 55 to 90% by weight, preferably from 65 to 85% by weight, more preferably from 70 to 82% by weight, based on the total weight of the inner layer fibers and the first resin.

The amount of the first resin may be controlled by the flow rate of the infusion device or equipment.

The temperature at which the first preform is heated and cured and the pultrusion speed are determined according to the type of the first resin. With different temperature settings, the pultrusion speed ranges from 0.1 to 2 m/min.

For example, a two-component polyurethane resin obtained by mixing and reacting component A (Desmodur 1511L) and component B (100 parts of Baydur 18BD001: 4 parts of Baydur 18BD101) in a weight ratio of 114:100 may have a curing temperature from 170 to 190° C. For example, in the case of heating with four regions, the temperatures in the four regions can be 40° C./60° C./190° C./170° C., and the first preform passes through the mold of 0.9-1.0 m at the speed of 0.4 m/min.

For example, Desmocomp AP200, an aliphatic urethane resin, may have a curing temperature of 200-220° C. For example, in the case of heating with four regions, the temperatures in the four regions can be 105° C./200° C./220° C./220° C., and the first preform passes through the mold of 0.9-1.0 m at the speed of 0.4 m/min.

The outer layer fibers may be any of the fibers used to reinforce the resin, for example, one or more selected from the group consisting of glass fibers, carbon fibers, polyester fibers, natural fibers, aromatic polyamide fibers, nylon fibers, basalt fibers, boron fibers, silicon carbide fibers, asbestos fibers, whiskers, and metal fibers.

The outer layer fibers may take the form of yarns, unidirectional fabrics, biaxial fabrics, triaxial fabrics, continuous felts, knitted felts, chopped strand felts, woven fabrics, knitted fabrics, and the like.

The second resin may be any resin that needs to be reinforced, for example, one or more selected from the group consisting of aromatic urethane, epoxy resin, unsaturated resin, aliphatic polyurethane, vinyl resin, and phenolic resin. Alternatively, the second resin may be a modified resin, for example, the above resin containing flame retardants and/or UV stabilizers.

The content of the outer fiber content generally ranges from 55 to 90% by weight, preferably from 65 to 85% by weight, more preferably from 70 to 82% by weight, based on the total weight of the outer layer fibers and the second resin.

The amount of the second resin may be controlled by the flow rate of the infusion device or equipment.

The temperature at which the second preform is heated and cured and the pultrusion speed are determined according to the type of the second resin.

The inner fibers and the outer fibers may be the same or different.

The first resin and the second resin may be the same or different.

According to a second aspect of the present invention, there is provided a fiber-reinforced composite prepared according to the pultrusion method in the first aspect of the present invention.

In some embodiments, the fiber-reinforced composite is a fiber-reinforced polyurethane composite.

The fiber-reinforced polyurethane composite can be used for preparing polyurethane tube boxes, bridge frames, anti-glare panels, doors and windows, curtain wall profiles, solar panel frames, fish boards, sleepers, shelves, trays, ladder frames, insulation rods, tent poles, container floor, third rail of the track, and so on.

According to a third aspect of the present invention, there is provided a pultrusion equipment for preparing a fiber-reinforced composite, comprising:
i) a first preforming device for receiving and preforming inner layer fibers;
ii) a first impregnating device for receiving the preformed inner layer fibers and impregnating the preformed inner layer fibers with a first resin to obtain a first preform;
iii) a first curing device for receiving the first preform and curing the first preform to obtain an inner layer profile;
iv) a second preforming device for receiving the outer layer fibers and the inner layer profile and preforming outer layer fibers with the inner layer profile;
v) a second impregnating device for receiving the preformed outer layer fibers and the inner layer profile and impregnating the outer layer fibers with a second resin to obtain a second preform;
vi) a second curing device for curing the second preform to obtain the fiber-reinforced composite; and
vii) a traction device for pulling the obtained fiber-reinforced composite.

In some embodiments, the equipment of the present invention may further comprise a resin storage device or a resin-producing device in fluid communication with the first impregnating device to provide the first resin to the first impregnating device.

In some embodiments, the equipment of the present invention may further comprise a resin storing device or a resin-producing device in fluid communication with the second impregnating device to provide the second resin to the second impregnating device.

In the case that the first resin and the second resin are the same, both the first resin and the second resin may be provided by the same storage device or resin-producing device, or respectively provided by separate storage devices or resin-producing devices.

The first preforming device and the second preforming device may be each independently a means having, for example, a circular hole or an oval hole for the passage of the fibers (yarns) or a waist-like hole or a slit through which the fabric or mat passes, e.g., a board.

The first impregnating device and the second impregnating device may be each independently selected from a low-pressure infusion box, a high-pressure infusion box, and an open dip bath.

The first curing device and the second curing device each have a heating system.

Thus, according to one preferred embodiment, the equipment of the present invention comprises:
a) a first preforming device for receiving and preforming inner layer fibers;
b) a first impregnating device for receiving the preformed inner layer fibers and impregnating the preformed inner layer fibers with a first resin to obtain a first preform;
c) a resin storage device or a resin-producing device in fluid communication with the first impregnating device to provide the first resin to the first impregnating device;
d) a first curing device for receiving the first preform and curing the first preform to obtain an inner layer profile, wherein the first curing device has a heating system;
e) a second preforming device for receiving the outer layer fibers and the inner layer profile and preforming outer layer fibers together with the inner layer profile;
f) a second impregnating device for receiving the preformed outer layer fibers and the inner layer profile and impregnating the outer layer fibers with a second resin to obtain a second preform;
g) a resin storing device or a resin-producing device in fluid communication with the second impregnating device to provide the second resin to the second impregnating device;
h) a second curing device for curing the second preform to obtain the fiber-reinforced composite, wherein the second curing device has a heating system; and
i) a traction device downstream of the second curing device for pulling the obtained fiber-reinforced composite.

By the method according to the present invention, it is possible to prepare a thicker fiber-reinforced composite.

By the method according to the present invention, it is also possible to combine the properties of different fibers/resins to prepare a fiber-reinforced composite having particular performance (for example, weather resistance, fire resistance, high strength and high modulus, and low cost).

Unless otherwise defined, all technical and scientific terms used herein have the same meaning as commonly understood by one of ordinary skill in the art to which this invention belongs. When the definition of the terms in this specification conflicts with the meaning commonly understood by those skilled in the art to which this invention belongs, the definition as defined herein shall prevail.

The present invention is exemplarily described below by way of Examples, but it should be understood that the scope of the present invention is not limited to these Examples.

### EXAMPLES

### Test Method Used in the Examples:

Short beam shear strength: Measured according to ASTM D2344.

### Materials Used in the Examples

Modified diphenylmethane diisocyanate: Desmodur 1511L, provided by Covestro Polymers (China) Co., Ltd.;

Polyol: Baydur 18BD001, provided by Covestro Polymers (China) Co., Ltd.;

Internal releasing agent: Baydur 18BD101, provided by Covestro Polymers (China) Co., Ltd.;

Aliphatic polyurethane: Desmocomp AP200, provided by Covestro Polymers (China) Co., Ltd.;

E-glass fiber yarn: ECT 469P-2400, provided by Chongqing Polycomp International Corporation.

### Example 1

Referring to FIG. 1, the pultrusion equipment for preparing a fiber-reinforced composite according to the present invention comprises: a first preforming device 2; a first impregnating device 3 downstream of the first preforming device 2; a first storage device or a resin-producing device (an first infusion machine, not shown) in fluid communication with the first impregnating device 3; a first curing device 4 downstream of the first impregnating device 3, the first curing device having a heating system (not shown); a second preforming device 7 downstream of the first curing device 4; a second impregnating device 8 downstream of the second preforming device 7; a second storage device or a resin-producing device (an second infusion machine, not shown) in fluid communication with the second impregnating device 8; a second curing device 9 downstream of the second impregnating device 8, the second curing device having a heating system (not shown); and a traction device 11 downstream of the second curing device 9.

Drawn from the creel, 238 bundles of inner layer glass fiber yarns 1 entered the first impregnating device (infusion box) 3 via the first preforming device 2, passed through the first curing device 4, and then entered the second curing device 9 along with 134 bundles of outer layer glass fiber yarns 6 via the second preforming device 7 and the second impregnating device (infusion box) 8. The glass fiber yarns 1 and glass fiber yarns 6 passed through the second curing device 9 were bound fast to a hauling rope, then the traction device 11 was switched on to haul the glass fiber yarns forward until they were straight. The heating system (not shown) of the first curing device 4 and the heating system (not shown) of the second curing device 9 were switched on, with the temperature of the first curing device 4 sequentially controlled from the inlet to the outlet as: 40° C./60° C./190° C./170° C., and the temperature of the second curing device 9 sequentially controlled from the inlet to the outlet as: 105° C./200° C./220° C./220° C. After the temperature was stabilized, the first infusion machine (not shown) was switched on. In the first infusion machine, component A (Desmodur 1511L) and component B (100 parts of Baydur 18BD001: 4 parts of Baydur 18BD101) were continuously pumped to the static mixing head at a weight ratio of 114:100 and mixed by the mixing head and then filled into the first infusion box 3 so that the glass fiber yarns 1 were sufficiently impregnated, and the infusion pressure in the first infusion box 3 was controlled in a range from 3 to 15 bar. The glass fiber yarns 1 impregnated with the first infusion box 3 were continuously hauled through the first curing device 4 at a rate of 0.4 m/min by the traction device 11 to form an inner layer profile 5 after being cured. After the inner layer profile 5 and the outer layer glass fiber yarns 6 passed through the second preforming device 7, the second infusion box 8 and the second curing device 9 sequentially, the second infusion machine (not shown) was switched on to fill the second infusion box 8 with aliphatic polyurethane Desmocomp AP200 so that the glass fiber yarns 6 were sufficiently impregnated, and the infusion pressure in the second infusion box 8 was controlled in a range from 3 to 15 bar. The glass fiber yarns 6 impregnated with the second infusion box 8 and the inner layer profile 5 were simultaneously and continuously hauled through the second curing device 9 at a rate of 0.4 m/min by the traction device 11 to form a glass fiber-reinforced composite 10 after being cured, with different resins in the inner and outer layers. The obtained glass fiber-reinforced composite 10 was cut into samples having a length of 500 mm by an in-situ cutting device (not shown), and then cut into testing sample for short beam test by a cutting device to be subjected to a mechanical strength test. The results are shown in Table 1.

### Example 2

Referring to FIG. 1, drawn from the creel, 192 bundles of inner layer glass fiber yarns 1 entered the first impregnating device (infusion box) 3 via the first preforming device 2, passed through the first curing device 4, and then entered the second curing device 9 along with 192 bundles of outer layer glass fiber yarns 6 via the second preforming device 7 and the second impregnating device (infusion box) 8. The glass fiber yarns 1 and glass fiber yarns 6 passed through the second curing device 9 were bound fast to a hauling rope, then the traction device 11 was switched on to haul the glass fiber yarns forward until they were straight. The heating system of the first curing device 4 and the heating system of the second curing device 9 were switched on, with the temperature of the first curing device 4 sequentially controlled from the inlet to the outlet as: 40° C./60° C./190° C./170° C., and the temperature of the second curing device 9 sequentially controlled from the inlet to the outlet as: 40° C./60° C./190° C./170° C. After the temperature was stabilized, the first infusion machine (not shown) was switched on to continuously pump component A (Desmodur 1511L) and component B (100 parts of Baydur 18BD001: 4 parts of Baydur 18BD101) to the static mixing head at a weight ratio of 114:100 and mix them by the mixing head and then filled into the first infusion box 3 so that the glass fiber yarns 1 were sufficiently impregnated, and the infusion pressure in the first infusion box 3 was controlled in a range from 3 to 15 bar. The glass fiber yarns 1 impregnated with the first infusion box 3 were continuously hauled through the first curing device 4 at a rate of 0.4 m/min by the traction device 11 to form an inner layer profile 5 after being cured. After the inner layer profile 5 and the outer layer glass fiber yarns 6 passed through the second preforming device 7, the second infusion box 8 and the second curing device 9 sequentially, the second infusion machine (not shown) was switched on to continuously pump component A (Desmodur 1511L) and component B (100 parts of Baydur 18BD001: 4 parts of Baydur 18BD101) to the static mixing head at a weight ratio of 114:100 and then filled into the second infusion box 8 so that the glass fiber yarns 6 were sufficiently impregnated, and the infusion pressure in the second infusion box 8 was controlled in a range from 3 to 15 bar. The glass fiber yarns 6 and the inner layer profile 5 impregnated with the second infusion box 8 were simultaneously and continuously hauled through the second curing device 9 at a rate of 0.4 m/min by the traction device 11 to form a glass fiber-reinforced composite 10 after being cured. The obtained glass fiber-reinforced composite 10 was cut into samples having a length of 500 mm by an in-situ cutting device (not shown), and then cut into testing sample for short beam test by a cutting device to be subjected to a mechanical strength test. The results are shown in Table 1.

### Comparative Example 1

Referring to FIG. 2, drawn from the creel, 372 bundles of glass fiber yarns 12 entered the impregnating device (infusion box) 14 via the preforming device 13, and finally entered the curing device 15 to be bound fast to a hauling rope, then the traction device 17 was switched on to haul the glass fiber yarns forward until they were straight. The temperature of the curing device 15 was sequentially controlled from the inlet to the outlet as: 105° C./200° C./220° C./220° C. After the temperature was stabilized, a first infusion machine (not shown) was switched on to fill the infusion box 14 with aliphatic polyurethane Desmocomp AP200 so that the glass fiber yarns 12 were sufficiently impregnated, and the infusion pressure in the infusion box 14 was controlled in a range from 3 to 15 bar. The glass fiber yarns 12 impregnated with the infusion box 14 were continuously hauled through the curing device 15 at a rate of 0.4 m/min by the traction device 17 to form a profile 16 after being cured. The obtained glass fiber-reinforced composite 16 was cut into samples having a length of 500 mm by an in-situ cutting device (not shown), and then cut into testing sample for short beam test by a cutting device to be subjected to a mechanical strength test. The results are shown in Table 1.

### Comparative Example 2

Referring to FIG. 2, drawn from the creel, 372 bundles of glass fiber yarns 12 entered the impregnating device (infusion box) 14 via the preforming device 13, and finally entered the curing device 15 to be bound fast to a hauling rope, then the traction device 17 was switched on to haul the glass fiber yarns forward until they were straight. The temperature of the curing device 15 was sequentially controlled from the inlet to the outlet as: 105° C./200° C./220° C./220° C. After the temperature was stabilized, an infusion machine (not shown) was switched on to continuously pump component A (Desmodur 1511L) and component B (100 parts of Baydur 18BD001: 4 parts of Baydur 18BD101) to the static mixing head at a weight ratio of 114:100 and mix them by the mixing head to fill an infusion box 14 so that the glass fiber yarns 12 were sufficiently impregnated, and the infusion pressure in the infusion box 14 was controlled in a range from 3 to 15 bar. The glass fiber yarns 12 impregnated with the infusion box 14 were continuously hauled through the curing device 15 at a rate of 0.4 m/min by the traction device 17 to form a profile 16 after being cured. The obtained glass fiber-reinforced composite 16 was cut into samples having a length of 500 mm by an in-situ cutting device (not shown), and then cut into testing samples for short beam splines by a cutting device to be subjected to a mechanical strength test. The results are shown in Table 1.

TABLE 1
Resins, Curing, and Performance
Characterization in Each Example

| | | | Short |
|---|---|---|---|
| | | | beam shear |
| | | | strength |
| Example No. | Resins | Curing | MPa |
| Example 1 | First resin: Component | Two-step curing | 49 |
| | A + Component B | according to the | |
| | Second resin: Aliphatic | present invention | |
| | polyurethane | | |
| | Desmocomp AP200 | | |
| Example 2 | First resin: Component | Two-step curing | 55 |
| | A + Component B | according to the | |
| | Second resin: Component | present invention | |
| | A + Component B | | |
| Comparative | Aliphatic polyurethane | Conventional | 50 |
| Example 1 | Desmocomp AP200 | one-step curing | |
| Comparative | Component A + | Conventional | 65 |
| Example 2 | Component B | one-step curing | |

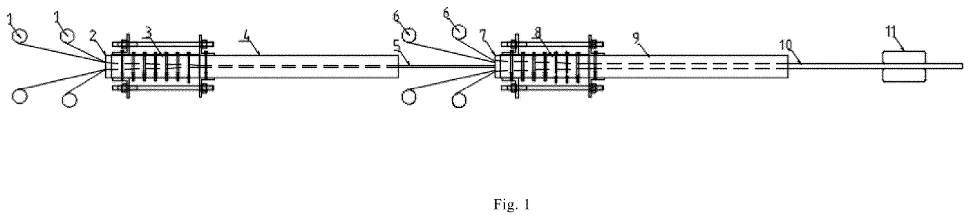

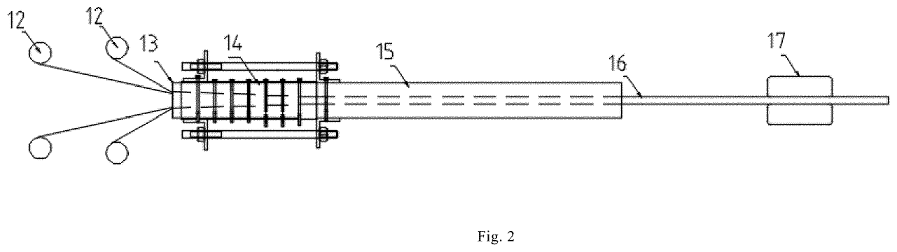

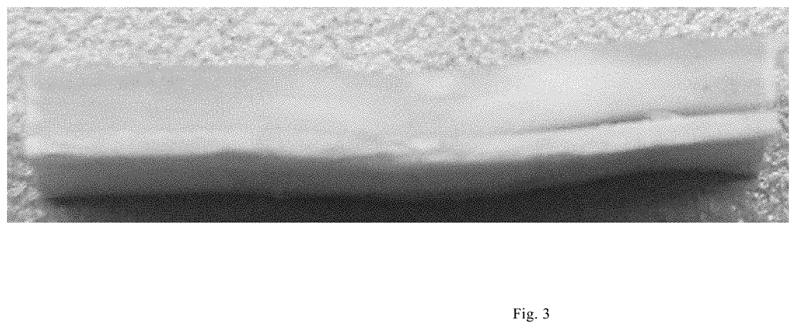

FIG. 3 is a photograph of the glass fiber-reinforced composite prepared in Example 1, the interface between two layers of resins was destroyed.

It can be seen from FIG. 3 that in the glass fiber-reinforced composite prepared in Example 1, the inner and outer layers of the resins did not intermingle and they have an apparent interface.

As can be seen from Table 1, the short beam shear strength of the glass fiber-reinforced composite prepared in Examples 1 and 2 is equivalent to that of the glass fiber-reinforced composite in Comparative Example 1, proving that there is a strong cohesional strength between two layers after being cured.

Although the invention has been described above in detail for the purpose of illustration of the invention, it should be understood that such detailed description is just exemplary. Except the content that may be defined by the claims, various changes can be made by those skilled in the art, without departing from the spirit and scope of the present invention.

1. A pultrusion method for preparing a fiber-reinforced composite, comprising the following steps:
i) preforming inner layer fibers;
ii) impregnating the preformed inner layer fibers with a first resin to obtain a first preform;
iii) heating and curing the first preform to obtain an inner layer profile;
iv) preforming outer layer fibers together with the inner layer profile;
v) impregnating the outer layer fibers with a second resin to obtain a second preform; and
vi) heating and curing the second preform to obtain the fiber-reinforced composite.

2. The pultrusion method according to claim 1, wherein the inner layer fibers and/or the outer layer fibers are one or more selected from the group consisting of: glass fibers, carbon fibers, polyester fibers, natural fibers, aromatic polyamide fibers, nylon fibers, basalt fibers, boron fibers, silicon carbide fibers, asbestos fibers, whiskers, and metal fibers.

3. The pultrusion method according to claim 1, wherein the first resin is one or more selected from the group consisting of: aromatic polyurethane, epoxy resin, unsaturated resin, aliphatic polyurethane, and vinyl resin.

4. The pultrusion method according to claim 1, wherein the content of the inner layer fiber ranges from 55 to 90% by weight, based on the total weight of the inner layer fibers and the first resin.

5. The pultrusion method according to claim 1, wherein the second resin is one or more selected from the group consisting of: aromatic urethane, epoxy resin, unsaturated resin, aliphatic polyurethane, vinyl resin, phenolic resin, and the above resins containing flame retardants and/or UV stabilizers.

6. The pultrusion method according to claim 1, wherein the content of the outer layer fiber ranges from 55 to 90% by weight, based on the total weight of the outer layer fibers and the second resin.

7. A fiber-reinforced composite prepared by the pultrusion method according to claim 1.

8. The fiber-reinforced composite according to claim 7, wherein the fiber-reinforced composite is a fiber-reinforced polyurethane composite.

9. A pultrusion equipment for preparing a fiber-reinforced composite, comprising:
i) a first preforming device for receiving and preforming inner layer fibers;
ii) a first impregnating device for receiving the preformed inner layer fibers and impregnating the preformed inner layer fibers with a first resin to obtain a first preform;
iii) a first curing device for receiving the first preform and curing the first preform to obtain an inner layer profile;
iv) a second preforming device for receiving the outer layer fibers and the inner layer profile and preforming outer layer fibers with the inner layer profile;
v) a second impregnating device for receiving the preformed outer layer fibers and the inner layer profile and impregnating the outer layer fibers with a second resin to obtain a second preform;
vi) a second curing device for curing the second preform to obtain the fiber-reinforced composite; and
vii) a traction device for pulling the obtained fiber-reinforced composite.

10. The pultrusion equipment according to claim 9, wherein the pultrusion equipment further comprises a resin storage device or a resin-producing device in fluid communication with the first impregnating device to provide the first resin to the first impregnating device.

11. The pultrusion equipment according to claim 9, wherein the pultrusion equipment further comprises a resin storing device or a resin-producing device in fluid communication with the second impregnating device to provide the second resin to the second impregnating device.

12. The pultrusion equipment according to claim 9, wherein the first preforming device and the second preforming device are each independently a means having a circular or oval or waist-like hole or slit.

13. The pultrusion equipment according to claim 9, wherein the first impregnating device and the second impregnating device are each independently selected from a low-pressure infusion box, a high-pressure infusion box, and an open dip bath.

14. The pultrusion equipment according to claim 9, wherein the first curing device and the second curing device each have a heating system.

15. The pultrusion method according to claim 1, wherein the content of the inner layer fiber ranges from 65 to 85% by weight, based on the total weight of the inner layer fibers and the first resin.

16. The pultrusion method according to claim 1, wherein the content of the inner layer fiber ranges from 70 to 82% by weight, based on the total weight of the inner layer fibers and the first resin.

17. The pultrusion method according to claim 1, wherein the content of the outer layer fiber ranges from 65 to 85% by weight, based on the total weight of the outer layer fibers and the second resin.

18. The pultrusion method according to claim 1, wherein the content of the outer layer fiber ranges from 70 to 82% by weight, based on the total weight of the outer layer fibers and the second resin.
